(19) United States
(12) Patent Application Publication
(10) Pub. No.: US 2022/0324267 A1
(43) Pub. Date: Oct. 13, 2022

(54) PNEUMATIC TIRE AND TIRE MOUNTING METHOD

(71) Applicant: TOYO TIRE CORPORATION, Itami-Shi (JP)

(72) Inventor: Tetsuji Miyazaki, Itami-shi (JP)

(73) Assignee: TOYO TIRE CORPORATION, Itami-Shi (JP)

(21) Appl. No.: 17/713,719

(22) Filed: Apr. 5, 2022

(30) Foreign Application Priority Data
Apr. 7, 2021 (JP) 2021-065466

(51) Int. Cl. B60C 13/00; B60C 13/02

(52) U.S. Cl. CPC B60C 13/001; B60C 13/02

(57) ABSTRACT

A pneumatic tire according to the present invention includes a first marking part provided on a surface of a first sidewall on one side in a tire axial direction and a second marking part provided on a surface of a second sidewall on the other side in the tire axial direction. The first marking part has a concave shape recessed from the surface of the first sidewall and the second marking part has a convex shape protruding from the surface of the second sidewall. The second marking part is provided at a position overlapping with the first marking part in the tire axial direction.

### BACKGROUND OF THE INVENTION

### 1. Field of the Invention

The present invention relates to a pneumatic tire and a tire mounting method.

### 2. Description of Related Art

A sidewall in a pneumatic tire is a portion facing an outer side of a vehicle when the tire is mounted on the vehicle. Accordingly, a marking that indicates a manufacturer's name, a brand name or the like by letters, a symbol or a figure may be provided on the sidewall as disclosed in, for example, JP-2020-1666 (Patent Literature 1).

Such marking is represented by protrusions protruding from an outer surface of the sidewall or recesses recessed from the outer surface of the sidewall. Accordingly, there may occur a difference in a rubber amount between a region where the marking is provided and a region where the marking is not provided. The difference in the rubber amount may deteriorate balance characteristics and affect vibration while running.

### SUMMARY OF THE INVENTION

The present invention has been made in view of the above circumstances, and an object thereof is to suppress deterioration of balance characteristics in the pneumatic tire provided with the marking on the outer surface of the sidewall.

A pneumatic tire according to the embodiment includes a first sidewall provided on one side in a tire axial direction, a second sidewall provided on the other side in the tire axial direction, a first marking part provided on a surface of the first sidewall, and a second marking part provided on a surface of the second sidewall, in which the first marking part has a concave shape recessed from a surface of the first sidewall, and the second marking part has a convex shape protruding from a surface of the second sidewall and provided at a position overlapping with the first marking part in the tire axial direction.

According to the present invention, it is possible to suppress deterioration of balance characteristics in the pneumatic tire provided with the marking on the outer surface of the sidewall.

### BRIEF DESCRIPTION OF THE DRAWINGS

FIG. 1 is a cross-sectional view of a pneumatic tire according to an embodiment of the present invention;

FIG. 2A is a side view of the pneumatic tire of FIG. 1 on one side in a tire axial direction;

FIG. 2B is a side view of the pneumatic tire of FIG. 1 on the other side in the tire axial direction;

FIG. 3 is an enlarged cross-sectional view of a relevant part in a sidewall on one side in the tire axial direction;

FIG. 4 is an enlarged cross-sectional view of a relevant part in a sidewall on the other side in the tire axial direction; and

FIG. 5 is a side view of a pneumatic tire on one side in the tire axial direction according to a modification example of the present invention.

### DESCRIPTION OF EMBODIMENTS

Hereinafter, an embodiment of the present invention will be explained with reference to the drawings.

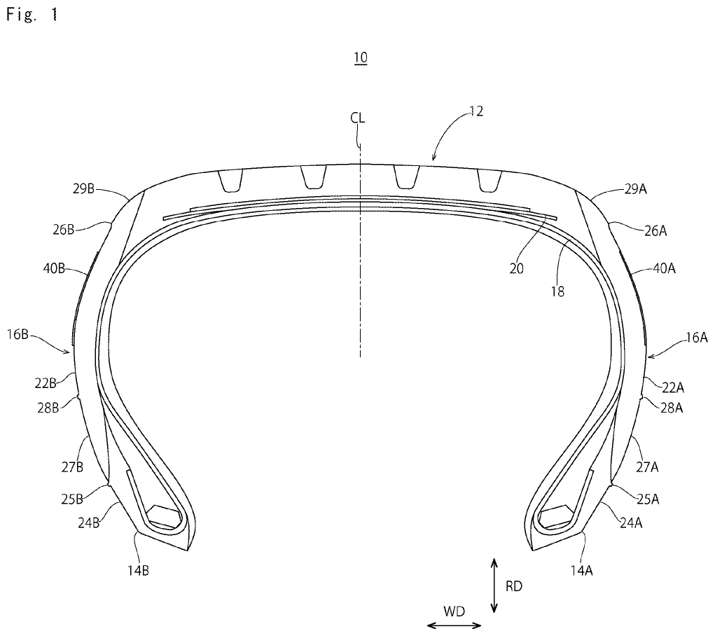

A pneumatic tire 10 according to the embodiment includes a tread 12 forming a grounding surface, a right and left pair of beads 14A, 14B, and a right and left pair of sidewalls 16A, 16B interposing between the tread 12 and the beads 14A, 14B as shown in FIG. 1.

The pneumatic tire 10 can adopt a well-known structure as an internal structure thereof, which is not particularly limited. In this example, a carcass ply 18 extending between the right and left beads 14A, 14B in a toroidal shape and a belt 20 arranged on an outer circumferential side (namely, an outer side in a tire radius direction) of the carcass ply 18 in the tread 12 are included.

In the pneumatic tire 10, marking parts and serrations provided on the sidewalls 16A, 16B differ between one side and the other side in a tire axial direction, and other structures are right-and-left symmetrical with respect to a tire equatorial plane CL.

In this specification, a tire axial direction WD is a direction parallel to a rotation axis when the tire is seen as a rotation body, which is the same as the tire width direction and shown by a symbol WD in the drawing. The tire radial direction (radial direction) is a radial direction of rotation when the tire is seen as the rotation body and shown by a symbol RD in the drawing. Moreover, a tire circumferential direction is a circumferential direction of rotation when the tire is seen as the rotation body and shown by a symbol CD in the drawing.

A first strip region 22A extending in the tire circumferential direction CD is provided on an outer surface of the sidewall (first sidewall) 16A on one side in the tire axial direction. A second strip region 22B extending in the tire circumferential direction CD is provided on an outer surface of the sidewall (second sidewall) 16B on the other side in the tire axial direction. In this example, the strip regions 22A, 22B are regions extending over the entire circumference in the tire circumferential direction CD with a fixed width.

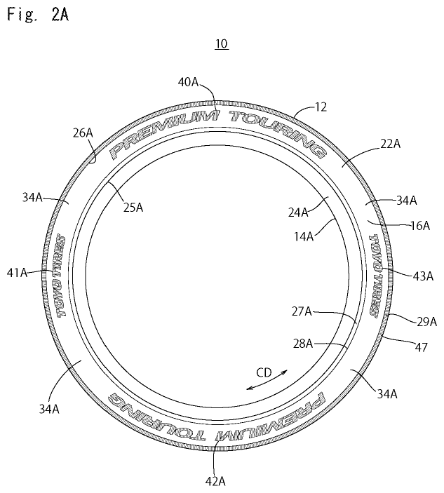

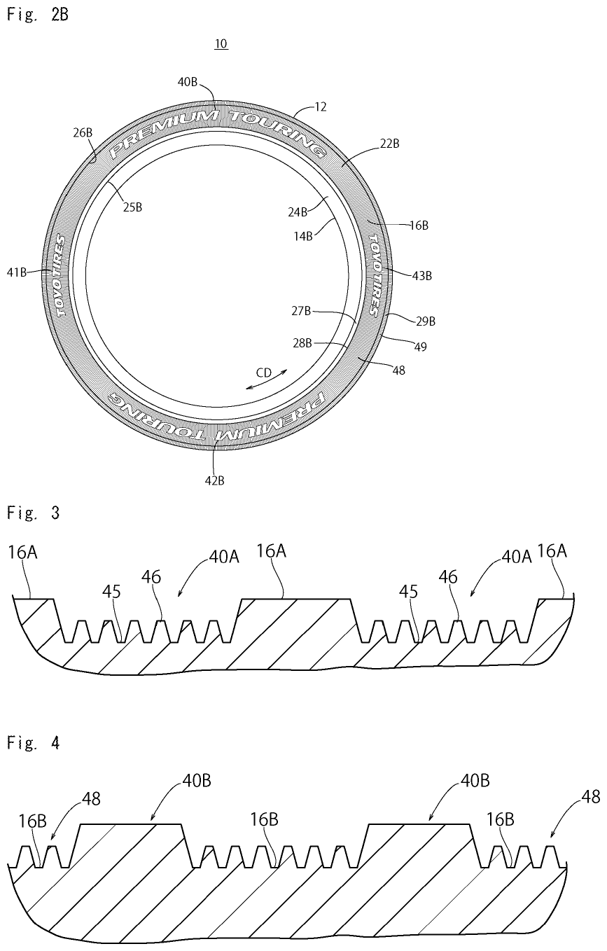

More specifically, the sidewalls 16A, 16B are regions sandwiched by rim protector ridges 25A, 25B provided at tops of rim protectors 24A, 24B and the tread 12 as shown in FIG. 1, FIGS. 2A and 2B. The rim protector ridges 25A, 25B are ridges molded by groove-shaped saw-cuts provided in a tire mold.

In this example, the outer surface of the first sidewall 16A is formed by including an annular first labeling region 27A, the annular first strip region 22A, and an annular first outer strip region 29A. The outer surface of the second sidewall 16B is formed by including an annular second labeling region 27B, the annular second strip region 22B, and an annular second outer strip region 29B.

The annular labeling regions 27A, 27B are regions for displaying regulatory labeling, which are provided adjacent to outer circumferences of the rim protector ridges 25A, 25B. The annular strip regions 22A, 22B are regions provided adjacent to outer circumferences of the labeling regions 27A, 28A. The outer strip regions 29A, 29B are regions provided adjacent to outer circumferences of the strip regions 22A, 22B.

Ridges molded by the groove-shaped saw-cuts provided in the tire mold may be formed at boundaries 28A, 28B between the labeling regions 27A, 27B and the strip regions 22A, 22B as shown in FIG. 1 as an example; however, it is not always necessary to form such ridges. Recessed grooves extending over the entire circumference in the tire circumferential direction CD may be formed at the boundaries 28A, 28B. Moreover, parting lines 26A, 26B which are dividing lines between a tread mold and a sidewall mold in the tire mold may be formed at boundaries between the strip regions 22A, 22B and the outer strip regions 29A, 29B.

As shown in FIG. 2A, a plurality of first marking parts 40A, 41A, 42A, and 43A are provided in the first strip region 22A of the first sidewall 16A on one side in the tire axial direction at intervals in the tire circumferential direction CD. In the embodiment, the plural marking parts 40A, 41A, 42A, and 43A are aligned in the tire circumferential direction CD in this order with unpatterned parts 34A with smooth surfaces where ridges and the like are not provided interposed therebetween.

The plural marking parts 40A, 41A, 42A, and 43A include letters, numbers, a symbol, a figure, or the like, indicating various information such as a manufacturer, a brand, a type, and a size of the tire.

The first marking parts 40A, 41A, 42A, and 43A have a concave shape recessed from the outer surface of the first sidewall 16A, namely, the unpatterned part 34A as shown in FIG. 3A. The first marking parts 40A, 41A, 42A, and 43A may be formed by arranging many ridges 46 which are ridges protruding from a bottom surface 45 at fixed intervals. A height of the ridges 46 is preferably lower than a depth of the first marking parts 40A, 41A, 42A, and 43A. Accordingly, the ridges 46 are formed to be lower than the outer surface of the first sidewall 16A in the preferred embodiment. A cross-sectional shape of the ridges 46 is not particularly limited and may be, for example, a trapezoidal shape, a triangular shape, a rectangular shape, and a semicircular shape.

It is preferable that each of the plural first marking parts 40A, 41A, 42A, and 43A is arranged at a position opposed to corresponding each of the plural first making parts 40A, 41A, 42A, and 43A with the tire rotation axis interposed therebetween. It is also preferable that the first marking parts opposed to each other include the same letters, numbers, symbol, figure, or the like.

In the embodiment, the first marking part 40A is arranged at a position opposed to the first marking part 42A with the tire rotation axis interposed therebetween as shown in FIG. 2A. The first marking part 41A is arranged at a position opposed to the first marking part 43A with the tire rotation axis interposed therebetween. The first marking part 40A and the first marking part 42A which are opposed to each other include the same letter string, and the first marking part 41A and the first marking part 43A which are opposed to each other include the same letter string.

That is, the first marking part 40A and the first marking part 42A are arranged in the first strip region 22A so that the first marking part 40A overlaps with the first marking part 42A when the first marking part 40A is rotated about the tire rotation axis by 180 degrees. The first marking part 41A and the first marking part 43A are arranged in the first strip region 22A so that the first marking part 41A overlaps with the first marking part 43A when the first marking part 41A is rotated about the tire rotation axis by 180 degrees.

A first serration 47 formed of many ridges protruding from the outer surface of the first sidewall 16A is provided in the first outer strip region 29A of the first sidewall 16A on one side in the tire axial direction. In the first serration 47, for example, many ridges extending along the tire radial direction are provided at intervals in the tire circumferential direction CD.

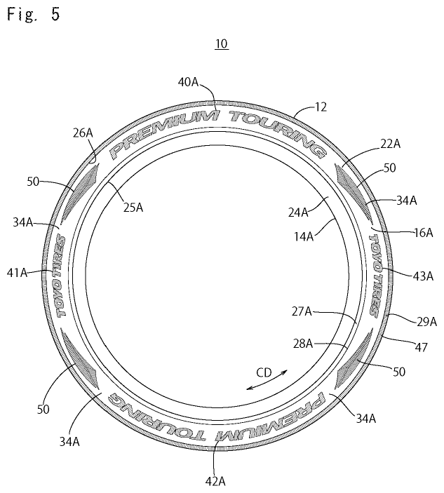

Note that first serrations 50 formed of many ridges may be provided, to an extent not deteriorating balance characteristics of respective tires, at parts of places where the first marking parts 40A, 41A, 42A, and 43A are not provided in the first strip region 22A, for example, between the first marking parts 40A and 41A, between 41A and 42A, between 42A and 43A, and between 43A and 40A as shown in FIG. 5. In the first serrations 50 provided in the first strip region 22A, ridges similar to the first serration 47 in the first outer strip region 29A may protrude from the outer surface of the first sidewall 16A. An example in which additional serrations are provided at parts of the first outer strip region 29A and the first strip region 22A is shown in FIG. 5; however, the first serrations may be provided only in the first strip region 22A. Moreover, an arbitrary decorative pattern can be adopted as a shape of the region where the first serration 50 is provided in the first strip region 22A when seen from the tire axial direction, which may be, for example, a flat shape in which one side gradually curves as shown in FIG. 5, and the shape is not particularly limited.

Furthermore, a plurality of second marking parts 40B, 41B, 42B, and 43B are provided in the second strip region 22B of the second sidewall 16B on the other side in the tire axial direction at intervals in the tire circumferential direction CD as shown in FIG. 2B. In the embodiment, the plural second marking parts 40B, 41B, 42B, and 43B are aligned at intervals in the tire circumferential direction CD in this order.

The plural second marking parts 40B, 41B, 42B, and 43B include letters, numbers, a symbol, a figure, or the like with a convex shape protruding from the outer surface of the second sidewall 16B, indicating various information such as a manufacturer, a brand, a type, and a size of the tire as shown in FIG. 2B and FIG. 4.

The second marking parts 40B, 41B, 42B, and 43B are provided at positions overlapping with, in the tire axial direction WD, the first marking parts 40A, 41A, 42A, and 43A provided in the first strip region 22A of the first sidewall 16A on one side in the tire axial direction.

That is, the second marking part 40B is arranged at a position overlapping with the first marking part 40A when being projected onto the first strip region 22A in the tire axial direction WD, the second marking part 41B is arranged at a position overlapping with the first marking part 41A when being projected onto the first strip region 22A in the tire axial direction WD, the second marking part 42B is arranged at a position overlapping with the first marking part 42A when being projected onto the first strip region 22A in the tire axial direction WD, and the second marking part 43B is arranged at a position overlapping with the first marking part 43A when being projected onto the first strip region 22A in the tire axial direction WD.

The second marking part 40B is arranged at a position opposed to the second marking part 42B with the tire rotation axis interposed therebetween. The second marking part 41B is arranged at a position opposed to the second marking part 43B with the tire rotation axis interposed therebetween. The second marking part 40B and the second marking part 42B which are opposed to each other include the same letter string, and the second making part 41B and the second marking part 43B which are opposed to each other include the same letter string.

In the embodiment, a case where each of pairs, which are the second marking part 40B and the first marking part 40A, the second marking part 41B and the first marking part 41A, the second marking part 42B and the first marking part 42A, and the second making part 43B and the first making part 43A, is composed of the same letter string and where the second making parts 40B, 41B, 42B, and 43B entirely correspond to the first marking parts 40A, 41A, 42A, and 43A when being projected in the tire axial direction WD will be explained. However, the second marking parts 40B, 41B, 42B, and 43B may include letters, numbers, a symbol, a figure, or the like which differ from those of the first marking parts 40A, 41A, 42A, and 43A as long as the second marking parts 40B, 41B, 42B, and 43B are provided so as to overlap with at least parts of the first marking parts 40A, 41A, 42A, and 43A in the tire axial direction WD.

Moreover, a case where four first marking parts 40A, 41A, 42A, and 43A and four second marking parts 40B, 41B, 42B, and 43B are respectively provided on surfaces of the sidewalls 16A, 16B will be explained; however, an arbitrary number of first marking parts and second marking parts can be provided on the surfaces of the sidewalls 16A, 16B. It is preferable that two or more first making parts and the second marking parts are respectively provided on the surfaces of the sidewalls 16A, 16B.

A recessed amount of the first marking parts 40A, 41A, 42A, and 43A from the surface of the first sidewall 16A and a protruding amount of the second marking parts 40B, 41B, 42B, and 43B from the surface of the second sidewall 16B are not particularly limited. For example, the recessed amount may be 0.2 to 1.0 mm and the protruding amount may be 0.2 to 3.0 mm.

A second serration 48 formed of many ridges protruding from the outer surface of the second sidewall 16B may be provided at the entire place where the second marking parts 40B, 41B, 42B, and 43B are not provided in the second strip region 22B or at least part thereof as shown in FIG. 2B and FIG. 4. A second serration 49 formed of many ridges protruding from the outer surface of the second sidewall 16B may be provided in the second outer strip region 29B. In the embodiment, an area of the second serrations 48, 49 provided in the second sidewall 16B on the other side in the tire axial direction is larger than an area of the first serration 47 provided in the first sidewall 16A on one side in the tire axial direction.

In the second serrations 48, 49, for example, many ridges extending along the tire radial direction are provided at intervals in the tire circumferential direction CD. In the embodiment, ridges provided in the second serration 48 are connected to ridges provided in the second serration 49 to form continuous ridges.

A cross-sectional shape of the ridges provided in the first serration 47 and the second serrations 48, 49 is not particularly limited and may be, for example, a trapezoidal shape, a triangular shape, a rectangular shape and a semicircular shape. The height of the ridges provided in the first serration 47 and the second serrations 48, 49 is not particularly limited and may be, for example, 0.2 to 1.0 mm. The width of the ridges is not particularly limited either and may be, for example, 0.2 to 2.0 mm. A pitch interval of the ridges (the minimum distance between centers of adjacent two ridges) is not particularly limited and may be, for example, 0.3 to 3.0 mm.

In the pneumatic tire 10 according to the embodiment, the first marking parts 40A, 41A, 42A, and 43A with the concave shape are provided on the surface of the first sidewall 16A on one side in the tire axial direction, and the second marking parts 40B, 41B, 42B, and 43B with the convex shape are formed on the surface of the second sidewall 16B on the other side in the tire axial direction at positions overlapping with the first marking parts in the tire axial direction WD.

According to the above, the rubber amount is balanced out between the first marking parts 40A, 41A, 42A, and 43A and the second marking parts 40B, 41B, 42B, and 43B which are arranged at overlapping positions in the tire axial direction WD when the marking parts with the convex shape and the concave shape are provided on the surfaces of the sidewalls 16A, 16B. Accordingly, the weight in the tire circumferential direction CD is equalized and the deterioration in balance characteristics can be suppressed.

Moreover, the first marking parts 40A, 41A, 42A, and 43A are provided at intervals in the tire circumferential direction so that each of the first marking parts is opposed to corresponding each of the first marking parts with the tire rotation axis interposed therebetween. The second marking parts 40B, 41B, 42B, and 43B are provided at intervals in the tire circumferential direction so that each of the second marking parts is opposed to corresponding each of the second marking parts with the tire rotation axis interposed therebetween in the pneumatic tire 10 according to the embodiment. Accordingly, the deterioration in balance characteristics of the tire can be suppressed.

When the pneumatic tire 10 according to the embodiment is mounted on a four-wheeled vehicle, it is preferable that tires are mounted on a left wheel on the front side and a right wheel on the front side respectively in the four-wheeled vehicle so that the first marking parts 40A, 41A, 42A, and 43A provided in the first sidewall 16A on one side in the tire axial direction face an outer side of the four-wheeled vehicle, or so that the second marking parts 40B, 41B, 42B, and 43B provided in the second sidewall 16B on the other side in the tire axial direction face the outer side of the four-wheeled vehicle.

When the pneumatic tire 10 in which deviation in tire weight occurs in the tire axial direction WD by providing the first marking parts 40A, 41A, 42A, and 43A with the concave shape in the first sidewall 16A on one side in the tire axial direction, and providing the second marking parts 40B, 41B, 42B, and 43B with the convex shape in the second sidewall 16B on the other side in the tire axial direction is mounted on the four-wheeled vehicle in the manner as described above, lateral forces (conicities) working on the left wheel and the right wheel of the four-wheeled vehicle while running are cancelled out to each other, as a result, straightness of the vehicle at the time of running can be improved.

The above embodiment is cited as an example and does not intend to limit the scope of the invention. The novel embodiment can be achieved in other various modes, and various omissions, replacements, modifications may occur in a scope not departing from the gist of the invention.

What is claimed is:

1. A pneumatic tire comprising:
a first sidewall provided on one side in a tire axial direction;
a second sidewall provided on the other side in the tire axial direction;
a first marking part provided on a surface of the first sidewall; and
a second marking part provided on a surface of the second sidewall,
wherein the first marking part has a concave shape recessed from a surface of the first sidewall, and
the second marking part has a convex shape protruding from a surface of the second sidewall and provided at a position overlapping with the first marking part in the tire axial direction.

2. The pneumatic tire according to claim 1,
wherein a plurality of first marking parts are provided at intervals in a tire circumferential direction so that each of the plurality of first marking parts is opposed to corresponding each of the plurality of first marking parts with a tire rotation axis interposed therebetween, and
a plurality of second marking parts are provided at intervals in the tire circumferential direction so that each of the plurality of second marking parts is opposed to corresponding each of the plurality of second marking parts with the tire rotation axis interposed therebetween.

3. The pneumatic tire according to claim 1, further comprising:
a first serration formed of a plurality of ridges aligned on the surface of the first sidewall at intervals; and
a second serration formed of a plurality of ridges aligned on the surface of the second sidewall at intervals,
wherein an area of the first serration provided on the surface of the first sidewall is smaller than an area of the second serration provided on the surface of the second sidewall.

4. The pneumatic tire according to claim 3, further comprising:
an annular first strip region and a first outer strip region provided adjacent to an outer circumference of the first strip region on the surface of the first sidewall,
wherein the first marking part is provided in the first strip region, and the first serration is provided in the first outer strip region.

5. The pneumatic tire according to claim 3, further comprising:
an annular second strip region on the surface of the second sidewall;
wherein the second marking part is provided in the second strip region, and the second serration is provided in at least part of a portion where the second marking part is not provided in the second strip region.

6. The pneumatic tire according to claim 5, further comprising:
the second strip region and a second outer strip region provided adjacent to an outer circumference of the second strip region on the surface of the second sidewall,
wherein the second serration is provided in the second outer strip region.

7. A tire mounting method for mounting the pneumatic tire according to claim 1 on a front wheel of a four-wheeled vehicle, comprising the step of:
mounting the pneumatic tires on a left wheel on a front side and a right wheel on the front side in the four-wheeled vehicle respectively so that the first marking part faces an outer side of the four-wheeled vehicle or the second marking part faces the outer side of the four-wheeled vehicle.

8. The pneumatic tire according to claim 2, further comprising:
a first serration formed of a plurality of ridges aligned on the surface of the first sidewall at intervals; and
a second serration formed of a plurality of ridges aligned on the surface of the second sidewall at intervals,
wherein an area of the first serration provided on the surface of the first sidewall is smaller than an area of the second serration provided on the surface of the second sidewall.

9. The pneumatic tire according to claim 4, further comprising:
an annular second strip region on the surface of the second sidewall;
wherein the second marking part is provided in the second strip region, and the second serration is provided in at least part of a portion where the second marking part is not provided in the second strip region.
